(19) United States
(12) Patent Application Publication
(10) Pub. No.: US 2005/0128180 A1
(43) Pub. Date: Jun. 16, 2005

(54) Portable presentation operating device

(76) Inventor: Chong-Min Wang, Taipei (TW)

Correspondence Address: BIRCH STEWART KOLASCH & BIRCH, PO BOX 747, FALLS CHURCH, VA, 22040-0747, US

(21) Appl. No.: 10/731,028

(22) Filed: Dec. 10, 2003

(51) Int. Cl. G09G 5/00

(52) U.S. Cl. 345/156

(57) ABSTRACT

This invention discloses a portable presentation operating device that can fully operate presentation software or perform multimedia playback functions under the Windows operating system of a computer via wireless communications. Such operating device comprises a wireless remote controller and a receiver installed in a computer system; wherein the remote controller is equipped with a four-key 8-dirctional cursor control press button for automatically changing the cursor speed in the Windows operating system according to the user's operating mode, and an instruction key equivalent to the press button of a mouse. In addition, this device also has the functions of a laser pointer. When users use presentation software to make a business presentation, this device can fully support the functions required for the operation of the presentation software.

### FIELD OF THE INVENTION

The present invention relates to a remote controller, more particularly to an operating device that can fully operate presentation software or perform multimedia playback functions under the Windows operating system of a computer via wireless communications.

### BACKGROUND OF THE INVENTION

In the past, a presentation software was used to make a business presentation in the Windows operating system of a personal computer, and a projector was used to project the image onto a screen. Besides using a mouse connected to the personal computer to control the cursor on the screen, we also use laser to give commands to or highlight the contents of the presentation. For the operation by using the mouse to control the cursor on the screen, such method is very inconvenient to the presenter who has to walk or stand at different positions frequency. Even a wireless mouse cannot solve such inconvenient problem. On the other hand, although it is apparently more convenient to use a laser pointer to point at the contents of the presentation on the screen, it is inconvenient for the presenter to operate and use the functions of the presentation software while using the laser pointer.

For the prior art of presentation indicators or remote control devices, the R.O.C. Patent No. 520110 entitled “Wireless presentation indication remote control device” has disclosed a portable wireless remote control device mainly equipped with an optical sensor. The user moves his/her finger on the surface of the optical sensor to control the movement of the cursor by the wireless remote control method, or can even use such remote control device as a mouse. However, such design of using an optical sensor to sense the user's finger movement usually causes error on the optical sensing, and thus causing inconvenience on its use.

Further, the R.O.C. Patent No. 304607 entitled “Remote control indicator for presentation system” has disclosed the design of a trackball used as the control component. However, according to our experience on using such device, the trackball design is not as convenient as that of the mouse.

Further, there were some presentation remote controllers using the design of a joystick or a 4-direction key to control the cursor movement for the operating interface. However, the users cannot adjust the cursor speed automatically as needed in the process of moving the cursor. It seems to be more tiring or inconvenient to move the cursor to a long distance.

### SUMMARY OF THE INVENTION

The primary objective of the present invention is to provide a wireless remote control presentation operating device, which can fully support the functions required for the operation of a presentation software.

The portable presentation operation device disclosed in this invention comprises a cursor control button set to control the cursor direction, and a press-button set having the press-button functions equivalent to those of a mouse and capable of substituting the mouse functions during a presentation, switching pages, and providing laser pointing. This invention supports all functions of a traditional mouse, and assists the function of laser pointing. With its portable feature, this invention provides a more convenient design to users and allows users to control the presentation without changing the current conditions regardless of the user's position.

Another objective of this invention is to provide a portable presentation operating device that can automatically change the cursor speed.

The portable presentation operation device disclosed in this invention further comprises a control mechanism that can change the cursor speed. Based on the time of the cursor control button set being pressed, a microcontroller is used to accumulate the pressing time and further control the cursor speed. As to a long-distance movement of the cursor, such device can improve the performance and convenience of the operation.

### BRIEF DESCRIPTION OF THE DRAWINGS

FIG. 1 is a front view of this invention.

FIG. 2 is a back view of this invention.

FIG. 3 is a perspective view of the receiver of this invention.

FIG. 4 is a block diagram of the circuit of this invention.

FIG. 5 is a flow chart of the operation of the microcontroller of this invention.

FIG. 6 is another block diagram of the circuit of this invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

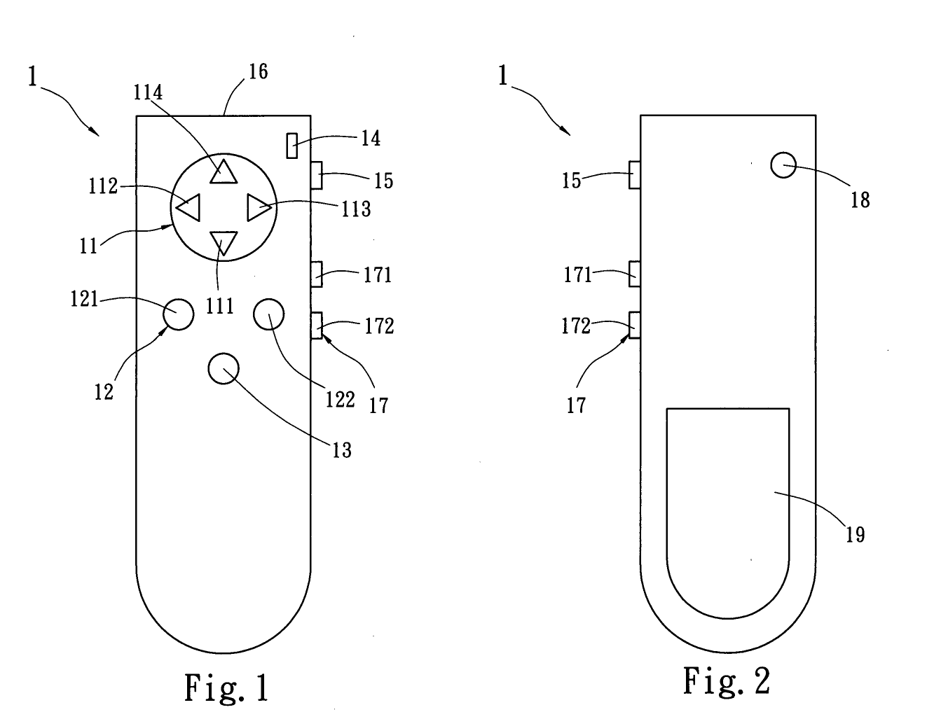

Please refer to FIGS. 1, 2, and 3. This invention comprises a remote controller 1 and a receiver 2. The remote controller 1 comprises:
a cursor control button set 11, having a substantially circular disk structure disposed on the remote controller 1, and the cursor control button set 11 comprises 4 cursor press buttons: a YU button 114 for controlling the cursor to move upward on the screen, a YD button 111 for controlling the cursor to move downward on the screen, a XL button 112 for controlling the cursor to move to the left on the screen, and a XR button 113 for controlling the cursor to move to the right on the screen; in addition, if the YU button 114 and the XL button 112 are pressed simultaneously, the cursor will move at an angle of 45 degrees towards the upper left corner; if the YU button 114 and the XR button 113 are pressed simultaneously, the cursor will move at an angle of 45 degrees towards the upper right corner; if the YD button 111 and the XL button 112 are pressed simultaneously, the cursor will move at an angle of 45 degrees towards the lower left corner; if the YD button 111 and the XR button 113 are pressed simultaneously, the cursor will move at an angle of 45 degrees towards the lower right corner; therefore, the pressing of these four cursor press buttons provides 8 different moving directions for the cursor; and
a mouse press button set 12, having a left mouse button 121, a right mouse button 122, which are equivalents to the left and right buttons of a general mouse respectively.

Please refer to FIG. 2 for the back of the remote controller 1, comprising a power supply unit 19 (could be a general dry cell or rechargeable battery) for providing the electric power required by the device, and a connection key 18 for calling the receiver 2 to set up the communication connection.

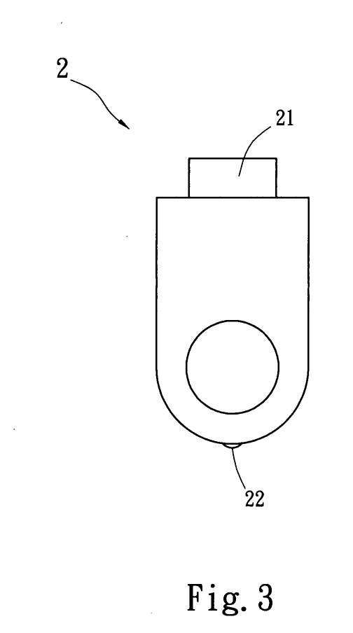

Please refer to FIG. 3 for the receiver 2, comprising a connection button 22 for polling the remote controller 1 to set up the communication connection, a USB connector 21 for connecting to the USB port of the computer, and the command is sent to the computer via the USB connector 21 in order to operate the functions of the presentation software.

To make the portable presentation operating device to have more complete functions, the remote controller 1 of this invention includes the following function keys in addition to the aforementioned function keys. Please refer to FIG. 1. These additional functions keys include:
A mode switching key 13, for switching the operation mode of the remote controller 1, such as a presenter mode and a media mode;
An indicating light (Green LED) 14 working together with the pressing of the mode switching key 13; when the operation mode of the remote controller 1 is in the presenter mode, the indicating light 14 is off; when the operation mode of the remote controller 1 is in the media mode, the indicating light 14 is in the blinking state (on);
   and the remote controller 1 at its sides comprises:
A laser pointing key 15, corresponding with its pressing status, and a laser transmitting end 16 at the front end of the remote controller 1 will project a laser beam onto the screen from the laser transmitting end 16 to highlight a location on the screen;
An operating press button set 17, comprising an Up button 171 and a Down button 172 equivalent to the Page Up and Page Down functions to switch the pages and scroll the window respectively.

By means of the foregoing mode switching key 13, a user can use any of the two operation modes of this invention: presenter mode and media mode. Then the device of this invention can be used as a mouse, and has a laser pointing function for clearly highlighting a position on the screen when a presentation is made. As to the media mode, it is used for controlling multimedia presentations.

If the mode switching key 13 is pressed to switch the remote controller 1 to the media mode and the YU button 114 of the cursor control press button set 11 is pressed to enter into the multimedia playback screen, then the user can start using the multimedia playback function.

The left mouse button 121 of the mouse press button set 12 is pressed to start the multimedia playback. If the right mouse button 122 is pressed again during the playback, then the multimedia playback will stop playing. When the right mouse button 122 is pressed, the multimedia playback is stopped.

The XL button 112 is pressed to have the backward function and replay previous screens; the XR button 113 is pressed to have a forward function, and the screen will play the next coming screens in advance; the laser pointer button 15 is pressed to mute the sound of the multimedia playback and the Up button 171 or Down button 172 of the operation press button set 17 is pressed to adjust the volume of the sound of the multimedia playback.

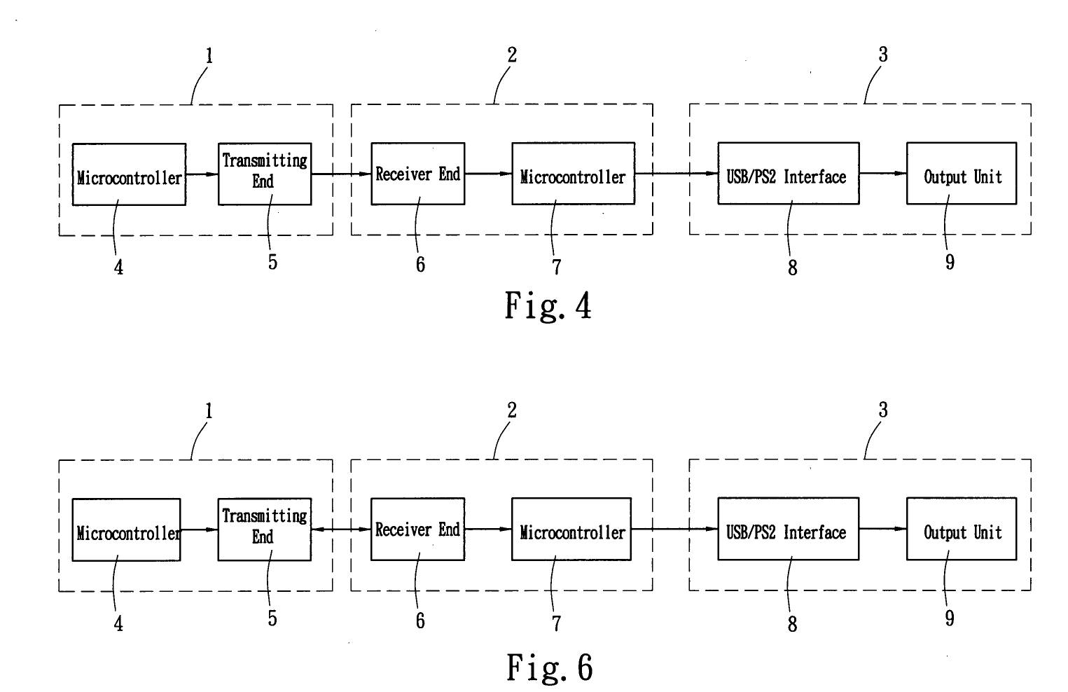

Please refer to FIG. 4 for the block diagram of the circuit of this invention. The one-way communication is adopted here for example. By pressing the foregoing press button, the corresponding electronic signal will be sent to the remote controller 1. A microcontroller 4 has a firmware in the remote controller 1, and such firmware will code the electronic signal, and transmit such signal from the transmitting end 5 of the remote controller 1 to the receiving end 6 of the receiver 2. After the receiving end 6 decodes such coded signal by the firmware of the microcontroller 7 of the receiver 2, the signal is sent to the output unit 9 of the computer 3 through the USB/PS2 interface 8 to perform the operation with respect to the pressed button.

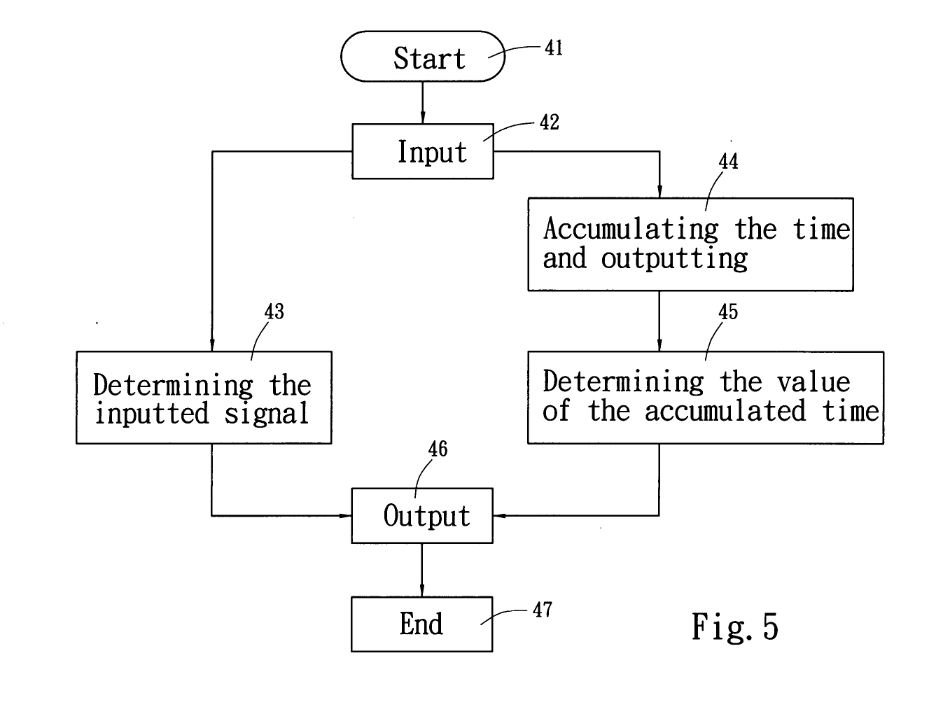

Please refer to FIG. 5 for the flow chart of a microcontroller 7 of the receiver 2 as shown in FIG. 4 to control the moving direction and the speed of the cursor control press button set 11. Firstly, a cursor press button is pressed to produce a signal which will be inputted to the microcontroller 7 (labeled as 42 in the FIG. 5). Then, the microcontroller 7 determines the cursor press button signal (labeled as 43 in FIG. 5) and outputs a corresponding signal for the cursor direction (labeled as 46 in FIG. 5). The microcontroller 7 starts calculating the time until the cursor press button signal is interrupted. If the cursor press button keeps on being pressed during the process, the microcontroller 7 will accumulate the pressing time (labeled as 44 in FIG. 5) and determine the time of pressing to execute the command (labeled as 45 in FIG. 5) of changing the cursor speed. The cursor speed is divided into several levels, and thus the longer the pressing time, the faster is the cursor speed, or else the cursor will be moved according to the original default speed.

Please refer to FIG. 6 for another block diagram of the circuit of this invention. Unlike the example illustrated in FIG. 4, the circuit here is for two-way communications. By pressing the press button, the corresponding electronic signal will be sent to the remote controller 1. The remote controller 1 has a microcontroller 4 inside, so that the electronic signal will be sent from the transmitting end 5 of the remote controller 1 to the receiving end 6 of the receiver 2 through the microcontroller 4. The receiver end 6 sends such electronic signal to the output unit 9 of the computer 3 through the USB/PS2 interface 8 by the microcontroller 7 of the receiver 2 to perform the corresponding operation of the press button. The difference between the foregoing embodiment and this embodiment resides on that the cursor speed of the cursor control press button set 11 is controlled by the time accumulated by the microcontroller 7 in the foregoing embodiment. In this embodiment, the time is accumulated by the microcontroller 7 of the receiver 2, or by the microcontroller 4 of the remote controller 1.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A portable presentation operating device, for fully operating a presentation software in a computer via wireless communications, comprising:
A remote controller, having a cursor control press button set and a microcontroller to control the cursor direction and speed, and said cursor control press button set having four cursor buttons respectively being Up, Down, Left, and Right buttons; when one of said four cursor buttons being pressed, the cursor moving in the up, down, left, and right directions in respect to the corresponding Up, Down, Left, and Right buttons, and when any two cursor press buttons being pressed, the cursor moving at an angle of substantially 45 degrees towards a direction selected from the group of upper right, lower right, upper left, and lower left directions;
a microcontroller, for producing a control command to control the cursor direction according to the pressing of said four cursor press buttons, and control the cursor speed according to the time of pressing said cursor press button.
a mouse press button set, disposed on said remote controller, and comprising a left mouse button and a right mouse button to produce said control command through said microcontroller to execute the function of the presentation software at the cursor position;
a power supply unit, disposed on said remote controller for supplying the electric power required by said remote controller;
a transmitting end for sending said control command in the form of a radio wave; and
a receiver, having a USB connector coupled to the USB port of a computer for receiving the control command transmitted from said remote controller to control the presentation software and cursor movement of the computer.

2. A portable presentation operating device according to claim 1, wherein said remote controller comprises a mode switching button for switching said presentation mode and media mode.

3. A portable presentation operating device according to claim 1, wherein said remote controller comprises a laser pointer button and a laser transmitting end; when said laser pointer button being pressed, said laser transmitting end transmitting a laser beam for users to point at a desired position by the laser beam.

4. A portable presentation operating device according to claim 1, wherein said remote controller comprises an operating press button set with two press buttons including an Up button and a Down button for switching the pages and scrolling the window respectively.

5. A portable presentation operating device according to claim 1, wherein said remote controller comprises a communication connection to call said receiver.

6. A portable presentation operating device according to claim 1, wherein said receiver comprises a connection button for setting up the communication connection to call said remote controller.
